(19) United States
(12) Patent Application Publication
(10) Pub. No.: US 2025/0293295 A1
(43) Pub. Date: Sep. 18, 2025

(54) SOLID-STATE BATTERY

(71) Applicant: HONDA MOTOR CO., LTD., Tokyo (JP)

(72) Inventors: Kizashi IWAKIRI, Saitama (JP); Takuya TANIUCHI, Saitama (JP); Tomohiko TSUZAKI, Saitama (JP)

(21) Appl. No.: 19/006,235

(22) Filed: Dec. 31, 2024

(30) Foreign Application Priority Data
Mar. 18, 2024 (JP) 2024-041931

(51) Int. Cl. H01M 10/0562; H01M 4/02; H01M 4/134; H01M 4/38; H01M 10/0525; H01M 10/0585

(52) U.S. Cl. CPC H01M 10/0562; H01M 4/134; H01M 4/382; H01M 10/0525; H01M 10/0585; H01M 2004/027; H01M 2300/0071

(57) ABSTRACT

Provided is a solid-state battery including an electrode stack in which a negative electrode, a solid electrolyte layer, and a positive electrode are sequentially stacked. The solid electrolyte layer includes a first solid electrolyte layer disposed on a side of the negative electrode. The positive electrode includes a positive electrode current collector and a positive electrode material mixture layer. A positive electrode current collector tab extends from one end of the positive electrode current collector. The positive electrode current collector tab has a low friction region formed on a surface thereof on a side facing the first solid electrolyte layer, the low friction region having a friction coefficient lower than that of the positive electrode current collector.

This application is based on and claims the benefit of priority from Japanese Patent Application No. 2024-041931, filed on 18 Mar. 2024, the content of which is incorporated herein by reference.

### BACKGROUND OF THE INVENTION

### Field of the Invention

The present invention relates to a solid-state battery.

### Related Art

In recent years, research and development has been conducted on solid-state batteries that contribute to energy efficiency in order to ensure that more people have access to affordable, reliable, sustainable, and advanced energy.

As a solid-state battery, an all-solid-state battery in which a solid electrolyte layer is disposed between a positive electrode and a negative electrode is known.

Japanese Unexamined Patent Application, Publication No. 2022-144855 discloses an all-solid-state battery including a positive electrode in which a positive electrode current collector layer and a positive electrode active material layer containing at least a solid electrolyte are laminated, a negative electrode in which a negative electrode current collector layer and a negative electrode active material layer containing at least a solid electrolyte are laminated, and a first solid electrolyte layer disposed between the positive electrode active material layer and the negative electrode active material layer. Here, in the all-solid-state battery, in a direction perpendicular to a lamination direction, the area of the negative electrode active material layer is larger than the area of the positive electrode active material layer. In a direction perpendicular to the lamination direction, the area of the first solid electrolyte layer is larger than the area of the positive electrode active material layer. The porosity n1ₐₘ of the positive electrode active material layer is 5% or less.

Japanese Unexamined Patent Application, Publication No. 2022-144855 discloses a method of producing an all-solid-state battery, including: a process in which pressurizing is performed when a positive electrode current collector layer and a positive electrode active material layer are laminated, and a positive electrode is formed; a process in which pressurizing is performed when a negative electrode current collector layer and a negative electrode active material layer are laminated, and a negative electrode is formed; and a process in which pressurizing is performed when the positive electrode, a first solid electrolyte layer, and the negative electrode are laminated in this order, and a laminate unit is formed.

Patent Document 1: Japanese Unexamined Patent Application, Publication No. 2022-144855

### SUMMARY OF THE INVENTION

However, with respect to the method of producing an all-solid-state battery disclosed in Japanese Unexamined Patent Application, Publication No. 2022-144855, when pressurizing is performed when the positive electrode, the first solid electrolyte layer, and the negative electrode are laminated in this order, the first solid electrolyte layer may enter an end portion of the positive electrode active material layer, and the first solid electrolyte layer may come into close contact with a positive electrode current collector tab. At this time, when pressurizing is further performed, since the end portion of the positive electrode active material layer is restrained by the first solid electrolyte layer, stress is concentrated and cracks occur in the positive electrode active material layer and the first solid electrolyte layer. As a result, the capacity and durability of the all-solid-state battery decrease.

An object of the present invention is to provide a solid-state battery capable of suppressing the occurrence of cracks in a positive electrode material mixture layer and a solid electrolyte layer during manufacturing.

A first aspect of the present invention is a solid-state battery including an electrode stack in which a negative electrode, a solid electrolyte layer, and a positive electrode are sequentially stacked. The solid electrolyte layer includes a first solid electrolyte layer disposed on a side of the negative electrode. The positive electrode includes a positive electrode current collector and a positive electrode material mixture layer. A positive electrode current collector tab extends from one end of the positive electrode current collector. When viewed from above in a stacking direction of the electrode stack, an outer periphery of the first solid electrolyte layer is located outside an outer periphery of the positive electrode material mixture layer. The positive electrode current collector tab has a low friction region formed on a surface thereof on a side facing the first solid electrolyte layer, the low friction region having a friction coefficient lower than that of the positive electrode current collector.

In a second aspect of the solid-state battery according to the first aspect, the low friction region includes a solid lubricant.

In a third aspect of the solid-state battery according to the first aspect, the low friction region includes a metal having a hardness higher than that of a material constituting the positive electrode current collector.

In a fourth aspect of the solid-state battery according to any one of the first to third aspects, the solid electrolyte layer further includes a second solid electrolyte layer disposed on a side of the positive electrode.

In a fifth aspect of the solid-state battery according to the fourth aspect, when viewed from above in the stacking direction of the electrode stack, the outer periphery of the first solid electrolyte layer is located outside an outer periphery of the second solid electrolyte layer.

In a sixth aspect of the solid-state battery according to any one of the first to fifth aspects, the solid-state battery is an all-solid-state lithium metal battery.

According to the present invention, it is possible to provide a solid-state battery capable of suppressing the occurrence of cracks in a positive electrode material mixture layer and a solid electrolyte layer during manufacturing.

### BRIEF DESCRIPTION OF THE DRAWINGS

FIG. 1 is a cross-sectional view showing a solid-state battery according to an embodiment of the present invention;

FIG. 2A is a cross-sectional view showing a state of the solid-state battery of FIG. 1 during pressing;

FIG. 2B is a cross-sectional view showing a state of the solid-state battery of FIG. 1 during pressing;

FIG. 3A is a cross-sectional view showing a state of the solid-state battery of FIG. 1 during pressing in a case where a low friction region A is not present; and

FIG. 3B is a cross-sectional view showing a state of the solid-state battery of FIG. 1 during pressing in the case where the low friction region A is not present.

### DETAILED DESCRIPTION OF THE INVENTION

Hereinafter, an embodiment of the present invention will be described with reference to the drawings.

### Solid-State Battery

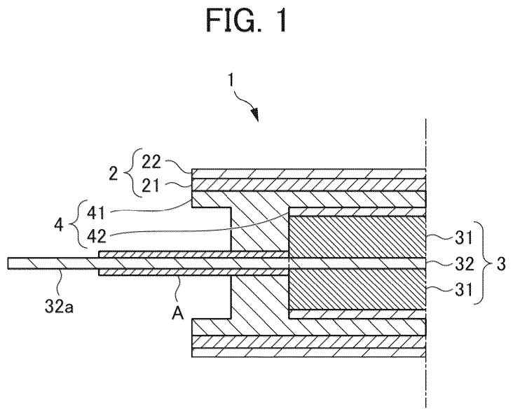

FIG. 1 shows a solid-state battery according to an embodiment of the present invention.

A solid-state battery 1 includes an electrode stack in which a negative electrode 2, a solid electrolyte layer 4, a positive electrode 3, a solid electrolyte layer 4, and a negative electrode 2 are sequentially stacked. Here, the solid electrolyte layer 4 includes a first solid electrolyte layer 41 disposed on the negative electrode 2 side and a second solid electrolyte layer 42 disposed on the positive electrode 3 side. A part of the first solid electrolyte layer 41 enters end portions of the positive electrode material mixture layer 31 and the second solid electrolyte layer 42. In the positive electrode 3, a positive electrode material mixture layer 31, a positive electrode current collector 32, and a positive electrode material mixture layer 31 are sequentially stacked in the stacking direction of the electrode stack. A positive electrode current collector tab 32a extends from one end of the positive electrode current collector 32. In the negative electrode 2, a negative electrode material mixture layer 21 and a negative electrode current collector 22 are sequentially stacked in the stacking direction of the electrode stack. A negative electrode current collector tab extends from the end of the negative electrode current collector 22 on the opposite side to the side where the positive electrode current collector tab 32a extends.

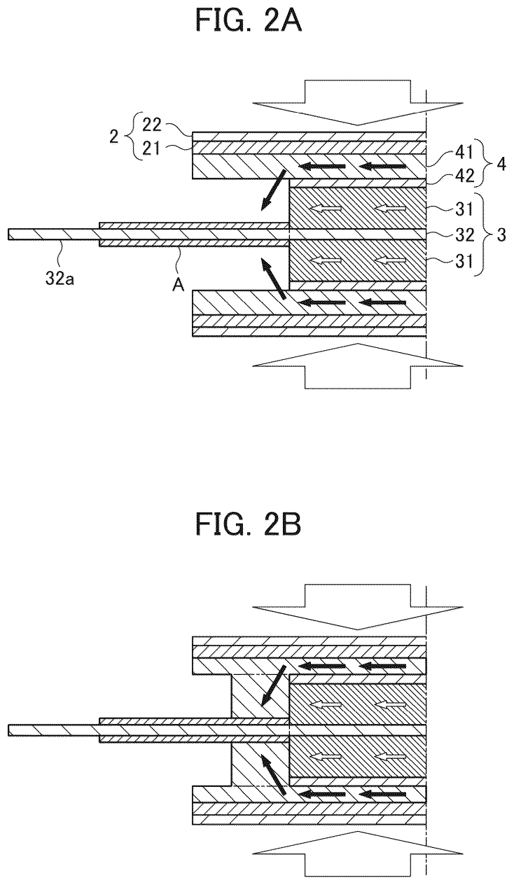

When the solid-state battery 1 is viewed from above in the stacking direction of the electrode stack, the outer peripheries of the negative electrode material mixture layer 21 and the first solid electrolyte layer 41 are located outside the outer peripheries of the positive electrode material mixture layer 31 and the second solid electrolyte layer 42. At this time, the outer periphery of the negative electrode material mixture layer 21 is present at substantially the same position as the outer periphery of the first solid electrolyte layer 41, and the outer periphery of the positive electrode material mixture layer 31 is present at substantially the same position as the outer periphery of the second solid electrolyte layer 42. In the positive electrode current collector tab 32a, a low friction region A having a friction coefficient lower than that of the positive electrode current collector 32 is formed in a region facing the first solid electrolyte layer 41. Therefore, when pressing is performed in a state where the negative electrode 2, the solid electrolyte layer 4, the positive electrode 3, the solid electrolyte layer 4, and the negative electrode 2 are sequentially stacked to manufacture the electrode stack, even if the first solid electrolyte layer 41 enters the end portions of the positive electrode material mixture layer 31 and the second solid electrolyte layer 42 (see FIG. 2A), the first solid electrolyte layer 41 does not come into close contact with the positive electrode current collector tab 32a (see FIG. 2B). At this time, even if pressing is further performed, since the end portions of the positive electrode material mixture layer 31 and the second solid electrolyte layer 42 are not restrained by the first solid electrolyte layer 41, stress is not concentrated, and the occurrence of cracks in the positive electrode material mixture layer 31 and the solid electrolyte layer 4 is suppressed. As a result, a decrease in capacity and a decrease in durability of the solid-state battery 1 are suppressed.

The low friction region A may be formed on the surface of the positive electrode current collector tab 32a on the side facing the first solid electrolyte layer 41, may be formed on the entire region of the surface of the positive electrode current collector tab 32a on the side facing the first solid electrolyte layer 41, or may be formed on a part of the surface of the positive electrode current collector tab 32a on the side facing the first solid electrolyte layer 41. The low friction region A may or may not be in contact with the positive electrode material mixture layer 31.

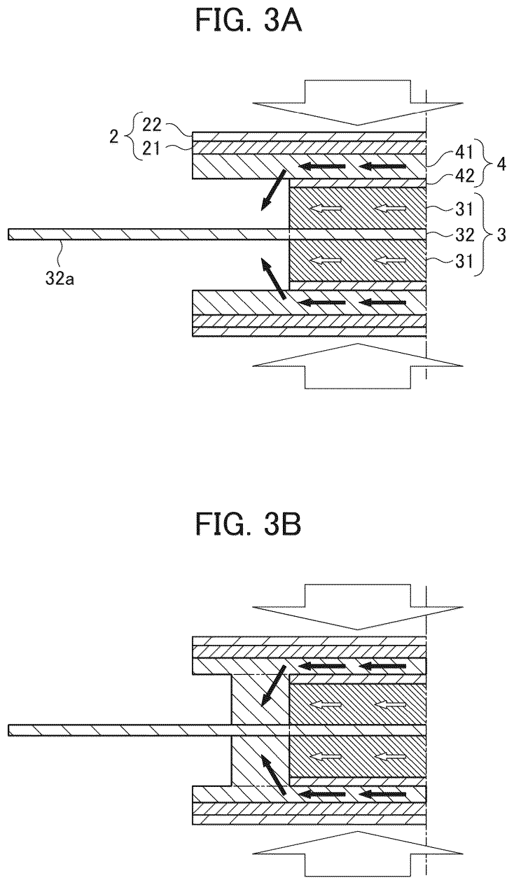

On the other hand, if the low friction region A is not formed on the surface of the positive electrode current collector tab 32a on the side facing the first solid electrolyte layer 41, when pressing is performed in a state where the negative electrode 2, the solid electrolyte layer 4, the positive electrode 3, the solid electrolyte layer 4, and the negative electrode 2 are sequentially stacked (see FIG. 3A), the first solid electrolyte layer 41 enters the end portions of the positive electrode material mixture layer 31 and the second solid electrolyte layer 42, and the first solid electrolyte layer 41 may come into close contact with the positive electrode current collector tab 32a (see FIG. 3B). At this time, when pressing is further performed, since the end portions of the positive electrode material mixture layer 31 and the second solid electrolyte layer 42 are restrained by the first solid electrolyte layer 41, stress is concentrated, and cracks occur in the positive electrode material mixture layer 31 and the solid electrolyte layer 4.

The material constituting the low friction region A is not limited, and examples thereof include a solid lubricant. Examples of the solid lubricant include polytetrafluoroethylene (PTFE). The method of forming the low friction region A including PTFE on the surface of the positive electrode current collector tab 32a is not limited, and examples thereof include a powder coating method.

Examples of the material constituting the low friction region A other than those described above include a metal having a hardness higher than that of the material constituting the positive electrode current collector 32. For example, in the case where the positive electrode current collector 32 includes aluminum, an example of a metal having a hardness higher than that of aluminum is stainless steel. The method of forming the low friction region A including stainless steel on the surface of the positive electrode current collector tab 32a is not limited, and examples thereof include a rolling method, a sputtering method, a vapor deposition method, and a plating method.

The surface roughness Ra (arithmetic average height) of the low friction region A is not limited, and is, for example, 0.2 μm or less.

The density of the region of the first solid electrolyte layer 41 facing the second solid electrolyte layer 42 is not limited, and is, for example, 0.5 g/cm³ or more and 6 g/cm³ or less. The thickness of the region of the first solid electrolyte layer 41 facing the second solid electrolyte layer 42 is not limited, and is, for example, 1 μm or more and 500 μm or less.

The density of the second solid electrolyte layer 42 is not limited, and is, for example, 0.5 g/cm³ or more and 6 g/cm³ or less. The thickness of the second solid electrolyte layer 42 is not limited, and is, for example, 1 μm or more and 500 μm or less.

The solid-state battery 1 is not limited as long as it includes an electrode stack in which the negative electrode 2, the solid electrolyte layer 4, and the positive electrode 3 are sequentially stacked. For example, the solid-state battery 1 may include a plurality of positive electrodes 3. The solid-state battery 1 may include a single negative electrode 2 and a single solid electrolyte layer 4. In this case, in the positive electrode 3, the positive electrode material mixture layer 31 and the positive electrode current collector 32 are sequentially stacked in the stacking direction of the electrode stack. The solid electrolyte layer 4 may not include the second solid electrolyte layer 42.

### Method of Manufacturing Solid-State Battery

Next, the method of manufacturing the solid-state battery 1 will be described.

### (First Solid Electrolyte Layer-Negative Electrode Stack)

A first solid electrolyte layer-negative electrode stack is obtained by performing pressing in a state where the material constituting the first solid electrolyte layer 41 is disposed on the surface of the negative electrode 2 on the side where the negative electrode material mixture layer 21 is disposed. The method of disposing the material constituting the first solid electrolyte layer 41 on the surface of the negative electrode 2 on the side where the negative electrode material mixture layer 21 is disposed is not limited, and is, for example, a method of transferring the first solid electrolyte layer 41 onto the negative electrode material mixture layer 21 using a first solid electrolyte layer transfer sheet. The first solid electrolyte layer transfer sheet is obtained by, for example, applying a slurry obtained by dispersing a solid electrolyte having a median diameter of 1 μm or less in a solvent to a support sheet and then drying the slurry. The pressing pressure is not limited, and is, for example, 10 MPa or more and 2000 MPa or less. The pressing temperature is not limited, and is, for example, not less than room temperature and not more than 1500° C.

### (Second Solid Electrolyte Layer-Positive Electrode Stack)

A second solid electrolyte layer-positive electrode stack is obtained by performing pressing in a state where the material constituting the second solid electrolyte layer 42 is disposed on the surfaces of the positive electrode 3 on both sides where the positive electrode material mixture layers 31 are disposed. The method of disposing the material constituting the second solid electrolyte layer 42 on the surfaces of the positive electrode 3 on both sides where the positive electrode material mixture layers 31 are disposed is not limited, and is, for example, a method of transferring the second solid electrolyte layer 42 onto the positive electrode material mixture layer 31 using a second solid electrolyte layer transfer sheet. The second solid electrolyte layer transfer sheet is obtained by, for example, applying a slurry obtained by dispersing a solid electrolyte having a median diameter of 1 μm or less in a solvent to a support sheet and then drying the slurry. The pressing pressure is not limited, and is, for example, 10 MPa or more and 2000 MPa or less. The pressing temperature is not limited, and is, for example, not less than room temperature and not more than 1500° C.

### (Electrode Stack)

An electrode stack is obtained by performing pressing in a state where the surface of the first solid electrolyte layer-negative electrode stack on the side where the first solid electrolyte layer 41 is disposed and the surface of the second solid electrolyte layer-positive electrode stack on the side where the second solid electrolyte layer 42 is disposed are disposed so as to face each other. The pressing pressure is not limited as long as it is possible to integrate the solid electrolyte layer 4, and is, for example, 10 MPa or more and 2000 MPa or less. The pressing temperature is not limited, and is, for example, not less than room temperature and not more than 1500° C.

The apparatus used in manufacturing the solid-state battery 1 is not limited, and examples thereof include a roll press apparatus and a flat plate press apparatus.

The solid-state battery 1 is not limited, and is, for example, an all-solid-state lithium metal battery. Hereinafter, a case where the solid-state battery 1 is an all-solid-state lithium metal battery will be described.

The negative electrode material mixture layer 21 is a lithium metal layer. The negative electrode current collector 22 is not limited, and is, for example, a copper foil.

The positive electrode material mixture layer 31 includes a positive electrode active material, and may further include a solid electrolyte, a conductivity aid, a binder, and the like. The positive electrode active material is not limited as long as it can occlude and release lithium ions, and is, for example, a lithium nickel cobalt manganese composite oxide. The solid electrolyte is not limited as long as it has lithium ion conductivity, and examples thereof include oxide-based electrolytes and sulfide-based electrolytes. The conductivity aid is not limited as long as it has electron conductivity, and is, for example, carbon black. The binder is not limited as long as it can improve the binding property, and is, for example, styrene-butadiene rubber.

The positive electrode current collector 32 is not limited, and is, for example, an aluminum foil.

The first solid electrolyte layer 41 and the second solid electrolyte layer 42 each include a solid electrolyte and may further include a binder or the like. The solid electrolyte is not limited as long as it has lithium ion conductivity, and examples thereof include inorganic solid electrolytes such as oxide-based electrolytes and sulfide-based electrolytes. The solid electrolytes constituting the first solid electrolyte layer 41 and the second solid electrolyte layer 42 may be the same or different. The binder is not limited as long as it can improve the binding property, and is, for example, styrene-butadiene rubber.

In the electrode stack, an intermediate layer having a function of allowing lithium metal to be uniformly deposited may be formed between the negative electrode 2 and the solid electrolyte layer 4. This stabilizes the interface between the intermediate layer and the first solid electrolyte layer 41. In this case, the solid-state battery 1 may be an anode-free battery in which a lithium metal layer as the negative electrode material mixture layer 21 is not formed at the time of the initial charge. In the anode-free battery, a lithium metal layer as the negative electrode material mixture layer 21 is formed after the initial charge and discharge.

The intermediate layer includes a metal capable of being alloyed with lithium and amorphous carbon, and may further include a binder or the like. The metal capable of being alloyed with lithium and the amorphous carbon are preferably nanoparticles. Examples of the metal capable of being alloyed with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). Examples of the amorphous carbon include carbon blacks such as acetylene black, furnace black, and Ketjen black, coke, and activated carbon. The amorphous carbon may be graphitizable carbon (soft carbon), or may be non-graphitizable carbon (hard carbon), CNT (carbon nanotube), fullerene, or graphene. The binder is not limited as long as it can improve the binding property, and is, for example, polyvinylidene fluoride (PVDF).

The thickness of the intermediate layer is not limited, and is, for example, 1 μm or more and 10 μm or less.

Although the embodiment of the present invention has been described above, the present invention is not limited to the above-described embodiment, and the above-described embodiment may be modified as appropriate within the scope of the gist of the present invention. For example, the solid-state battery 1 may further include an exterior body (e.g., a laminate film) that covers the exterior of the electrode stack.

### EXPLANATION OF REFERENCE NUMERALS

1 solid-state battery
2 negative electrode
21 negative electrode material mixture layer
22 negative electrode current collector
3 positive electrode
31 positive electrode material mixture layer
32 positive electrode current collector
32a positive electrode current collector tab
4 solid electrolyte layer
41 first solid electrolyte layer
42 second solid electrolyte layer
A low friction region

What is claimed is:

1. A solid-state battery comprising:
an electrode stack in which a negative electrode, a solid electrolyte layer, and a positive electrode are sequentially stacked,
wherein the solid electrolyte layer comprises a first solid electrolyte layer disposed on a side of the negative electrode,
wherein the positive electrode comprises a positive electrode current collector and a positive electrode material mixture layer, and a positive electrode current collector tab extends from one end of the positive electrode current collector,
wherein, when viewed from above in a stacking direction of the electrode stack, an outer periphery of the first solid electrolyte layer is located outside an outer periphery of the positive electrode material mixture layer, and
wherein the positive electrode current collector tab has a low friction region
formed on a surface thereof on a side facing the first solid electrolyte layer, the low friction region having a friction coefficient lower than that of the positive electrode current collector.

2. The solid-state battery according to claim 1, wherein the low friction region comprises a solid lubricant.

3. The solid-state battery according to claim 1, wherein the low friction region comprises a metal having a hardness higher than that of a material constituting the positive electrode current collector.

4. The solid-state battery according to claim 1, wherein the solid electrolyte layer further comprises a second solid electrolyte layer disposed on a side of the positive electrode.

5. The solid-state battery according to claim 4, wherein, when viewed from above in the stacking direction of the electrode stack, the outer periphery of the first solid electrolyte layer is located outside an outer periphery of the second solid electrolyte layer.

6. The solid-state battery according to claim 1, wherein the solid-state battery is an all-solid-state lithium metal battery.
